(19) United States
(12) Patent Application Publication
(10) Pub. No.: US 2012/0042656 A1
(43) Pub. Date: Feb. 23, 2012

(54) GAS TURBINE ENGINE WITH EXHAUST RANKINE CYCLE

(75) Inventors: Frank Wegner Donnelly, North Vancouver (CA); David William Dewis, North Hampton, NH (US); John D. Watson, Evergreen, CO (US)

(73) Assignee: ICR TURBINE ENGINE CORPORATION, Hampton, NH (US)

(21) Appl. No.: 13/215,026

(22) Filed: Aug. 22, 2011

Related U.S. Application Data
(60) Provisional application No. 61/375,646, filed on Aug. 20, 2010.

(51) Int. Cl. F02C 7/10

(52) U.S. Cl. 60/772; 60/39.511

(57) ABSTRACT

A closed-loop organic Rankine cycle apparatus to extract waste heat from the exhaust gas from a gas turbine engine is disclosed wherein the closed loop includes at least one additional heat exchanger. An additional heat exchanger for heating fuel may be in one of three locations relative to the ORC turbine and condensing heat exchanger. One location is a preferred location for adding heat to all fuels (liquid, gaseous and/or cryogenic). Another location is a practical location for adding heat to very cold or cryogenic fuels such as CNG or LNG. The closed-loop organic Rankine cycle apparatus, besides extracting waste heat from the exhaust gases, may also include an additional heat exchanger to recover heat from a compressor on a gas turbine engine prior to entering an intercooler on a gas turbine engine.

In another embodiment, the exhaust stream can be directed, in selected proportions, to a closed organic Rankine cycle, a heat exchanger for pre-heating fuel or directly out an exhaust stack.

### CROSS REFERENCE TO RELATED APPLICATION

The present application claims the benefits, under 35 U.S.C.§119(e), of U.S. Provisional Application Ser. No. 61/375,646 entitled “Gas Turbine Engine with Exhaust Rankine Cycle “, filed on Aug. 20, 2010 and which is incorporated herein by reference.

### FIELD

The present disclosure relates generally to gas turbine engine systems and specifically to the addition of a Rankine cycle apparatus to extract energy from the exhaust stream to pre-heat and/or pressurize a fuel or generate electrical energy and thereby improve overall fuel efficiency.

### BACKGROUND

There is a growing requirement for alternate fuels for vehicle propulsion. These include fuels such as natural gas, bio-diesel, ethanol, butanol, hydrogen and the like. Means of utilizing fuels needs to be accomplished more efficiently and with substantially lower carbon dioxide emissions and other air pollutants such as NOxs.

The gas turbine or Brayton cycle power plant has demonstrated many attractive features which make it a candidate for advanced vehicular propulsion. Gas turbine engines have the advantage of being highly fuel flexible and fuel tolerant (that is, relatively unaffected by variations in fuel LHV and octane rating). Additionally, these engines burn fuel at a lower temperature than reciprocating engines so produce substantially less NOxs per mass of fuel burned. By being able to utilize different fuels, highly efficient, compact gas turbine power plants can take advantage of known techniques to pre-heat fuels and improve overall fuel efficiency. This is especially true for multi-fuel vehicles such as described in U.S. patent application Ser. No. 13/090,104 filed Apr. 19, 2011, entitled “Multi-Fuel Vehicle Strategy” which is incorporated herein by reference

There remains a need for practical methods and apparatuses to extract energy from the engine's exhaust stream to continue to improve overall engine efficiency for vehicles and power generation using gas turbine engines.

### SUMMARY

These and other needs are addressed by the present disclosure. In one embodiment, the present disclosure contemplates a closed-loop organic Rankine cycle apparatus to extract waste heat from the exhaust gases from a gas turbine engine where the closed loop includes at least one additional heat exchanger. The additional heat exchanger for heating fuel may be in one of three locations. The first is just before the ORC turbine, the second is just after the ORC turbine and before the condensing heat exchanger and the third is after the condensing heat exchanger. The first location is a preferred location for adding heat to all fuels (liquid, gaseous and/or cryogenic). The second location is a practical location for adding heat to all cryogenic fuels such as LNG. The third location is a practical location for adding heat to cryogenic fuels such as LNG when the second location is inaccessible for example. The fuel used by the gas turbine engine is passed through this additional heat exchanger and thereby uses the heat in the organic Rankine cycle to pre-heat and/or pressurize the fuel stream prior to injection into the combustion chamber or reheater in a gas turbine engine. Both the energy generated in the organic Rankine cycle and the energy that pre-heats the fuel originate in the exhaust stream which is otherwise discarded, these energy additions will result in an increase in fuel efficiency of the gas turbine power plant.

The Rankine cycle may include an economizer which is an additional heat exchanger. Addition of an economizer is prior art.

The closed-loop organic Rankine cycle apparatus, besides extracting waste heat from the exhaust gases, may also include an additional heat exchanger to recover heat from the input to an intercooler on a gas turbine engine. The heat may be recovered from the output of any compressor preceding an intercooling stage and may allow the intercooler to be reduced in size while increasing the overall efficiency of the organic Rankine cycle.

In another embodiment, the exhaust stream can be directed, in selected proportions, to a closed organic Rankine cycle, a heat exchanger for directly pre-heating fuel or directly out the exhaust pipe.

In one embodiment, an apparatus is disclosed, comprising a heat exchange system operable to transfer thermal energy from an exhaust stream of a gas turbine engine to a fuel stream of a gas turbine engine to preheat and/or pressurize the fuel stream for combustion in the gas turbine engine. A corresponding method is disclosed comprising transferring, by a heat exchange system, thermal energy from an exhaust stream of a gas turbine engine to a fuel stream of a gas turbine engine to preheat and/or pressurize the fuel stream for combustion in the gas turbine engine.

In another embodiment, a system is disclosed comprising an exhaust path selector, the exhaust path selector being operable to select a path for a gas turbine engine exhaust gas, wherein a first path comprises a heat exchanger to transfer thermal energy from the exhaust gas to a fuel stream for the gas turbine engine, a second path comprises an exhaust to the environment, and a third path comprises a closed organic Rankine cycle apparatus.

In another embodiment, a method is disclosed comprising a) sensing at least one of a state-of-charge of an energy storage battery, rate of consumption of auxiliary power, temperature of a fuel supply, rate of consumption of a fuel supply, and power level of an engine; b) based on the sensed at least one of a state-of-charge of an energy storage battery, rate of consumption of auxiliary power, temperature of a fuel supply, rate of consumption of a fuel supply, and power level of an engine, determining a proportion of an exhaust stream directed at least one of a fuel heat exchanger for pre heating fuel, an exhaust stream heat exchanger which is part of a closed organic Rankine cycle and an exhaust stack fluidly connected to the atmosphere; and c) in response to step (b), setting a control valve to direct the exhaust stream to the at least one of a fuel heat exchanger for pre heating fuel, an exhaust stream heat exchanger which is part of a closed organic Rankine cycle and an exhaust stack fluidly connected to the atmosphere.

In another embodiment, a method is disclosed comprising a) estimating the time of at least one of a projected requirement for a state-of-charge of an energy storage battery, rate of consumption of auxiliary power, temperature of a fuel supply, rate of consumption of a fuel supply and power level of an engine; b) based on the at least one of a of a projected requirement for a state-of-charge of an energy storage battery, rate of consumption of auxiliary power, temperature of a fuel supply, rate of consumption of a fuel supply and power level of an engine, estimating the proportions of an exhaust stream to be directed at least one of a fuel heat exchanger for pre heating fuel, an exhaust stream heat exchanger which is part of a closed organic Rankine cycle and an exhaust stack fluidly connected to the atmosphere; and c) in response to step (b), at the estimated time, setting a control valve to direct the exhaust stream to at least one of a fuel heat exchanger for pre heating fuel, an exhaust stream heat exchanger which is part of a closed organic Rankine cycle and an exhaust stack fluidly connected to the atmosphere.

In another embodiment, an apparatus is disclosed comprising an organic Rankine cycle operatively connected to a gas turbine engine; at least one of an electrical energy generator and a second compressor powered by a turbine in the organic Rankine cycle; and at least one intercooler heat exchanger in fluid communication with the organic Rankine cycle to transfer thermal energy from a compressed gas output of a compressor of the gas turbine engine to the working fluid. . A corresponding method is disclosed comprising providing an organic Rankine cycle, a gas turbine engine, at least one of an electrical energy generator and a second compressor, and at least one intercooler heat exchanger; transferring, by the intercooler heat exchanger. thermal energy from a compressed gas output of a compressor of the gas turbine engine to a working fluid of the Rankine cycle to form a heated working fluid; and driving, by the heated working fluid, a turbine, the turbine being operatively connected to the at least one of an electrical energy generator and a second compressor.

These and other advantages will be apparent from the disclosure of the invention(s) contained herein.

The above-described embodiments and configurations are neither complete nor exhaustive. As will be appreciated, other embodiments of the invention are possible utilizing, alone or in combination, one or more of the features set forth above or described in detail below.

The following definitions are used herein:

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term automatic and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

CNG means Compressed Natural Gas.

The term computer-readable medium as used herein refers to any tangible or non-transient storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible or non-transient storage medium. When the computer-readable media is configured as a database, it is to be understood that the database may be any type of database, such as relational, hierarchical, object-oriented, and/or the like. Accordingly, the disclosure is considered to include a tangible or non-transient storage medium or distribution medium and prior art-recognized equivalents and successor media, in which the software implementations of the present disclosure are stored.

Economizers are heat exchange devices that heat fluids up to but not normally beyond the boiling point of that fluid. Economizers can make use of the enthalpy in fluid streams that are hot, but not hot enough to be used efficiently in a heating apparatus, thereby recovering more useful enthalpy and improving the heating apparatus efficiency. They are a device fitted to a heating apparatus which reccovers energy by using the exhaust gases from the ORC turbine to preheat the cold fluid before injection to the heating apparatus.

An energy storage system refers to any apparatus that acquires, stores and distributes mechanical or electrical energy which is produced from another energy source such as a prime energy source, a regenerative braking system, a third rail and a catenary and any external source of electrical energy. Examples are a battery pack, a bank of capacitors, a pumped storage facility, a compressed air storage system, an array of a heat storage blocks, a bank of flywheels or a combination of storage systems.

An engine is a prime mover and refers to any device that uses energy to develop mechanical power, such as motion in some other machine. Examples are diesel engines, gas turbine engines, microturbines, Stirling engines and spark ignition engines.

A free power turbine as used herein is a turbine which is driven by a gas flow and whose rotary power is the principal mechanical output power shaft. A free power turbine is not connected to a compressor in the gasifier section, although the free power turbine may be in the gasifier section of the gas turbine engine. A power turbine may also be connected to a compressor in the gasifier section in addition to providing rotary power to an output power shaft.

An intercooler heat exchanger as used herein means a heat exchanger positioned between the output of a compressor of a gas turbine engine and the input to an intercooler of a gas turbine engine. It is noted that an intercooler itself is a heat exchanger. Air, or in some configurations, an air-fuel mix is introduced into a gas turbine engine and its pressure is increased by passing through at least one compressor. If there is an intercooler heat exchanger, this fluid passes through the hot side of the intercooler heat exchanger. It then passes through the hot side of the intercooler itself which is just upstream of the compressor.

Jake brake or Jacobs brake describes a particular brand of engine braking system. It is used generically to refer to engine brakes or compression release engine brakes in general, especially on large vehicles or heavy equipment. An engine brake is a braking system used primarily on semi-trucks or other large vehicles that modifies engine valve operation to use engine compression to slow the vehicle. They are also known as compression release engine brakes.

LNG means Liquified Natural Gas. Natural gas becomes a liquid when cooled to a temperature of about 112 K or lower.

A mechanical-to-electrical energy conversion device refers an apparatus that converts mechanical energy to electrical energy or electrical energy to mechanical energy. Examples include but are not limited to a synchronous alternator such as a wound rotor alternator or a permanent magnet machine, an asynchronous alternator such as an induction alternator, a DC generator, and a switched reluctance generator. A traction motor is a mechanical-to-electrical energy conversion device used primarily for propulsion.

The term module as used herein refers to any known or later developed hardware, software, firmware, artificial intelligence, fuzzy logic, or combination of hardware and software that is capable of performing the functionality associated with that element. Also, while the disclosure is presented in terms of exemplary embodiments, it should be appreciated that individual aspects of the disclosure can be separately claimed

An organic Rankine cycle (ORC) is based on the use of an organic, high molecular mass fluid with a liquid-vapor phase change, or boiling point, occurring at a lower temperature than the water-steam phase change. The fluid allows Rankine cycle heat recovery from lower temperature sources such as biomass combustion, industrial waste heat, geothermal heat, heat from a vehicle exhaust stream and the like. The low-temperature heat is converted into useful work that may include conversion into electrical energy. The working principle of the organic Rankine cycle is the same as that of the Rankine cycle. That is, the working fluid is pumped to a boiler or heat exchanger where it is evaporated, passes through a turbine and is finally re-condensed. The expansion is adiabatic. The evaporation and condensation processes are substantially isobaric.

A prime power source refers to any device that uses energy to develop mechanical or electrical power, such as motion in some other machine. Examples are diesel engines, gas turbine engines, microturbines, Stirling engines, spark ignition engines and fuel cells.

Power density as used herein is power per unit volume (watts per cubic meter).

A recuperator as used herein is a gas-to-gas heat exchanger dedicated to returning exhaust heat energy from a process back into the pre-combustion process to increase process efficiency. In a gas turbine thermodynamic cycle, heat energy is transferred from the turbine discharge to the combustor inlet gas stream, thereby reducing heating required by fuel to achieve a requisite firing temperature.

Regenerative braking is the same as dynamic braking except the electrical energy generated is recaptured and stored in an energy storage system for future use.

Specific power as used herein is power per unit mass (watts per kilogram).

Spool means a group of turbo machinery components on a common shaft.

A thermal energy storage module is a device that includes either a metallic heat storage element or a ceramic heat storage element with embedded electrically conductive wires. A thermal energy storage module is similar to a heat storage block but is typically smaller in size and energy storage capacity.

A turbine is any machine in which mechanical work is extracted from a moving fluid by expanding the fluid from a higher pressure to a lower pressure.

Turbine Inlet Temperature (TIT) as used herein refers to the gas temperature at the outlet of the combustor which is closely connected to the inlet of the high pressure turbine and these are generally taken to be the same temperature.

A turbo-compressor spool assembly as used herein refers to an assembly typically comprised of an outer case, a radial compressor, a radial turbine wherein the radial compressor and radial turbine are attached to a common shaft. The assembly also includes inlet ducting for the compressor, a compressor rotor, a diffuser for the compressor outlet, a volute for incoming flow to the turbine, a turbine rotor and an outlet diffuser for the turbine. The shaft connecting the compressor and turbine includes a bearing system. The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below.

### BRIEF DESCRIPTION OF THE DRAWINGS

The disclosure may take form in various components and arrangements of components, and in various steps and arrangements of steps. The drawings are only for purposes of illustrating the preferred embodiments and are not to be construed as limiting the invention. In the drawings, like reference numerals refer to like or analogous components throughout the several views

FIG. 1 is a schematic of a prior art gas turbine engine architecture.

FIG. 2 is a schematic of a prior art organic Rankine cycle apparatus powered by the exhaust stream of a gas turbine engine.

FIG. 3 is a schematic of a prior art organic Rankine cycle apparatus, with economizer, powered by the exhaust stream of a gas turbine engine.

FIG. 4 is a schematic of a Rankine cycle apparatus powered by the exhaust stream of a gas turbine engine, for pre-heating fuel in a first position.

FIG. 5 is a schematic of a Rankine cycle apparatus powered by the exhaust stream of a gas turbine engine, for pre-heating fuel in a second position.

FIG. 6 is a schematic of a Rankine cycle apparatus powered by the exhaust stream of a gas turbine engine, for pre-heating fuel in a third position.

FIG. 7 is a schematic of a switchable exhaust stream system.

FIG. 8 is a schematic of an organic Rankine cycle apparatus with economizer and combined fuel heat condensing heat exchanger.

FIG. 9 is a schematic of a Rankine cycle apparatus powered by a portion of the heat that is to be rejected by an intercooler and the exhaust stream of a gas turbine engine, for pre-heating fuel in a first position.

FIGS. 10a and 10b is a flow chart for switchable exhaust control.

### DETAILED DESCRIPTION

### Preferred Engine

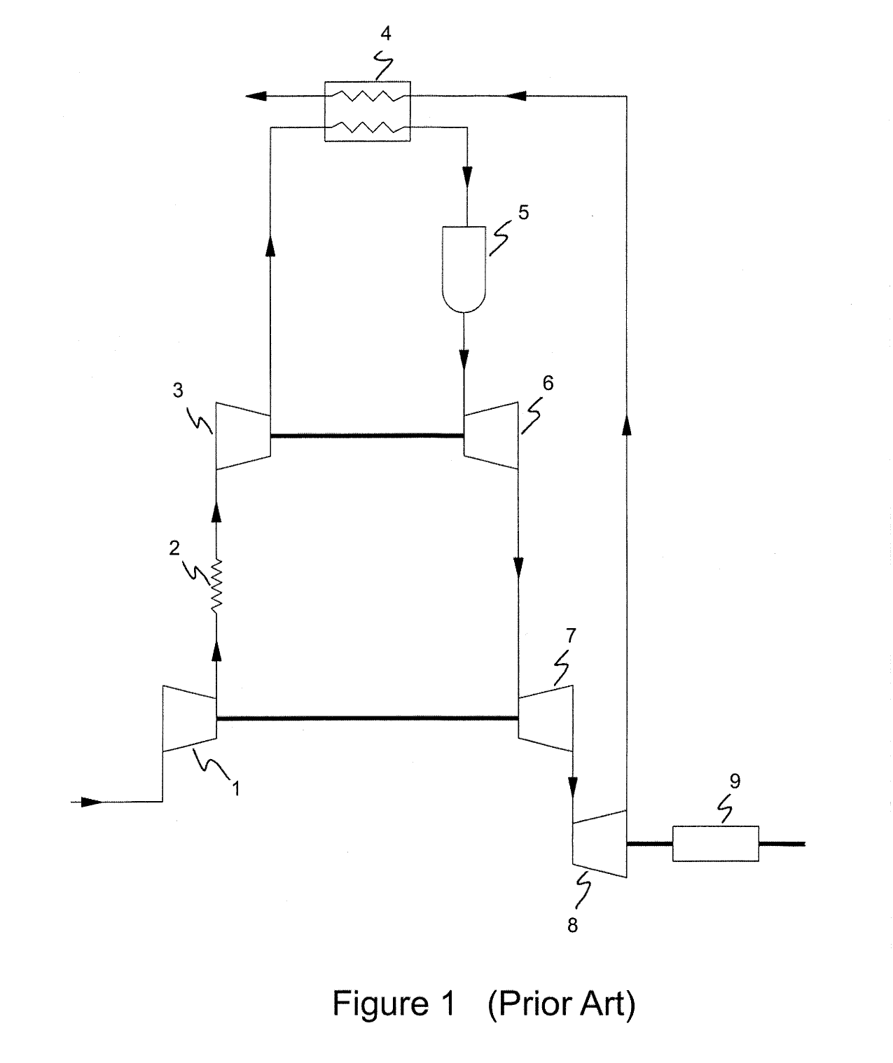

A preferred engine type is a high efficiency gas turbine engine because it typically has lower NOx emissions, is more fuel flexible, fuel tolerant and has lower maintenance costs. For example, an intercooled recuperated gas turbine engine in the 10 kW to 650 kW range is available with thermal efficiencies above about 40%. A schematic of the component arrangement of an intercooled recuperated gas turbine engine that is capable of this level of thermal efficiency is shown in FIG. 1.

FIG. 1 is schematic of the component architecture of a prior art multi-spool gas turbine engine. Air (or in some configurations, an air-fuel mix) is ingested into a low pressure compressor 1. The outlet of the low pressure compressor 1 passes through an intercooler 2 which removes a portion of heat from the gas stream at approximately constant pressure. The gas then enters a high pressure compressor 3. The outlet of high pressure compressor 3 passes through the cold side of a recuperator 4 where a significant portion of the heat from the exhaust gas is transferred, at approximately constant pressure, to the gas flow from the high pressure compressor 3. The further heated gas from recuperator 4 is then directed to a combustor 5 where a fuel is reacted or burned, adding heat energy to the gas flow at approximately constant pressure. The gas emerging from the combustor 5 then enters a high pressure turbine 6 where work is done by the turbine to operate the high pressure compressor 3. The gas from the high pressure turbine 6 then drives a low pressure turbine 7 where work is done by the turbine to operate the low pressure compressor 1. The gas from the low pressure turbine 7 then drives a free power turbine 8. The shaft of the free power turbine, in turn, drives a load 1 lwhich may be an electrical, mechanical or hybrid transmission for a vehicle or an electrical generator for power generation. This engine design is described, for example, in U.S. patent application Ser. No. 12/115,134 filed May 5, 2008, entitled “Multi-Spool Intercooled Recuperated Gas Turbine”, which is incorporated herein by this reference.

Variations of this engine architecture may include a reheater and/or thermal energy storage devices such as described, for example, in U.S. patent application Ser. No. 13/175,564 filed Jul. 1, 2011, entitled “Improved Multi-Spool Intercooled Recuperated Gas Turbine” which is incorporated herein by reference. Other variations of this engine may have multiple stages of intercooling and reheat. One such engine design is disclosed in U.S. Provisional Application No. 61/501,552, filed Jun. 27, 2011 entitled “Advanced Cycle Gas Turbine Engine” which is incorporated herein by reference.

### Rankine Cycle

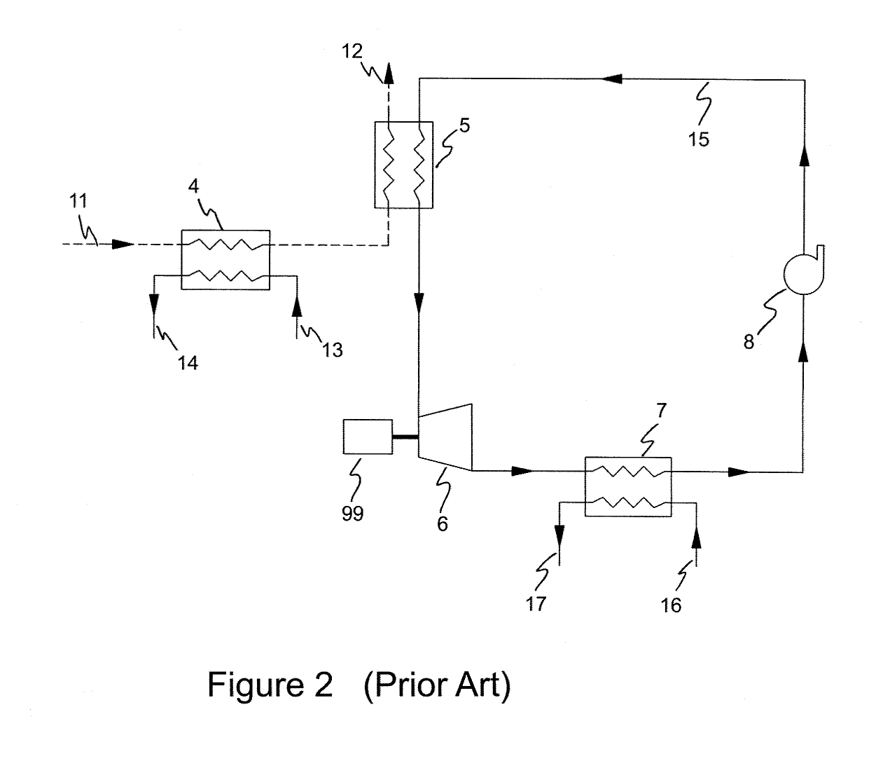

FIG. 2 is a schematic of a prior art organic Rankine cycle apparatus powered by the exhaust stream of a gas turbine engine. This figure shows a recuperator 4 which can be, for example, the recuperator on a gas turbine engines such as shown in FIG. 1. The exhaust stream from the gas turbine (dashed line) enters the hot side of recuperator 4 via path 11. After passing through recuperator 4, the engine exhaust gas that has passed through the hot side is usually released to the atmosphere. However, in this configuration, the engine exhaust is first directed to an exhaust stream heat exchanger 5. The air or air-fuel mixture that flows through the gas turbine engine is shown entering the cold side of recuperator 4 via path 13 and exiting the cold side of recuperator 4 via path 14 after gaining heat from the exhaust stream passing through the hot side of recuperator 4.

In FIG. 2, the exhaust that has passed through the hot side of recuperator 4 now passes through the hot side of exhaust stream heat exchanger 5 before being released to the atmosphere via path 12. The fluid, in liquid form, of a closed-loop organic Rankine cycle (“ORC”) passes through the cold side of heat exchanger 5 where it picks up heat energy from the gas turbine engine exhaust stream. The fluid passing through the cold side of heat exchanger 5 enters in a liquid state and exits in a gaseous state or mixed phase state and so increases in pressure and volume. The now-gaseous or mixed phase, pressurized working fluid then powers a turbine 6 which extracts energy from the closed cycle working fluid. ORC turbine 6 is shown powering a load 99 which could be, for example, an electrical generator or a compressor. The gaseous or mixed phase working fluid then goes through the hot side of a condensing heat exchanger 7 where energy is extracted and typically released to the atmosphere, causing the working fluid to condense back to a liquid state. Ambient air is shown entering the cold side of condensing heat exchanger 7 via path 16 and exiting the cold side of heat exchanger 7 via path 17. The now-liquid working fluid is then pumped back around the closed Rankine cycle loop by pump 8 to exhaust stream heat exchanger 5. As can be appreciated, the ambient air used in the cold side of condensing heat exchanger 7 can be replaced by ambient water in certain applications such as marine or some power generation applications for example.

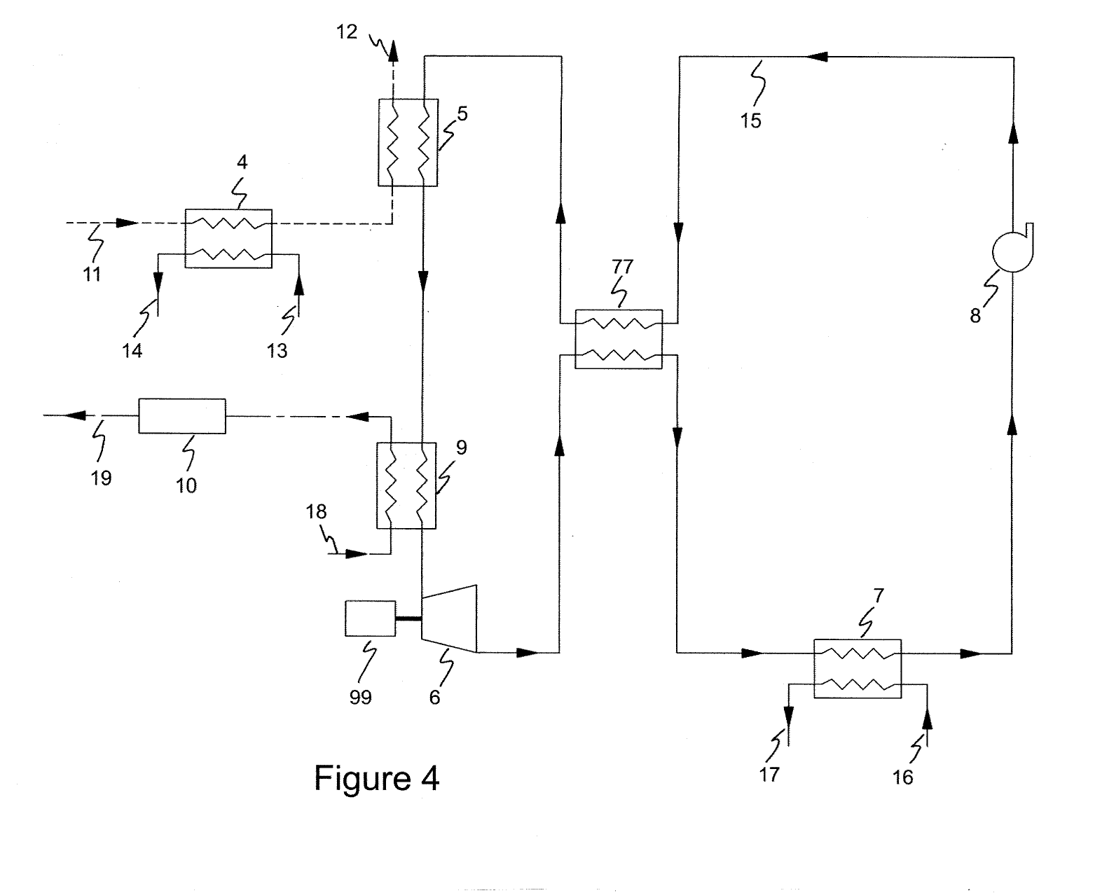

As an example, consider a 377 kW gas turbine engine at full power. The recuperator hot side outlet temperature is about 545 K (the exhaust gas temperature without an ORC). Assuming an ORC system in which the exhaust stream heat exchanger transfers 240,000 J/s (240 kW) to the ORC working fluid, the estimated exhaust temperature would be reduced to about 355 K at the outlet of the exhaust stream heat exchanger (the new exhaust gas temperature with the above ORC). This assumes an exhaust stream heat exchanger with an effectiveness of about 80%. If the ORC uses about 1.0 kg/s of HFC 245fa as its working fluid and pumps the liquid working fluid to about 200 psi, then an 85% efficient ORC turbine will extract about 40,300 J/s (40.3 kW). This represents an efficiency of about 17% for the ORC cycle (shaft energy out of the ORC turbine divided by heat transferred to the ORC working fluid through the exhaust stream heat exchanger). This also represents an increase in overall gas turbine engine efficiency of about 4.7% since the total gas turbine engine output has increased from about 377 kW to about 417 kW for a fuel LHV of 870,000 J/s or 870 kW (that is, overall engine thermal efficiency increases from about 43.3% to about 48.0%). This example will be used as the basis for utilizing the ORC to pre-heat fuel as discussed in FIG. 4. It is not an optimized organic fluid and it may be possible to extract substantially more energy from the ORC turbine.

Possible organic fluids for the ORC of FIG. 2 are: pentafluoropropane, freon and the like as well as most of the other traditional refrigerants—iso-pentane, CFCs, HFCs, butane, propane, and ammonia.

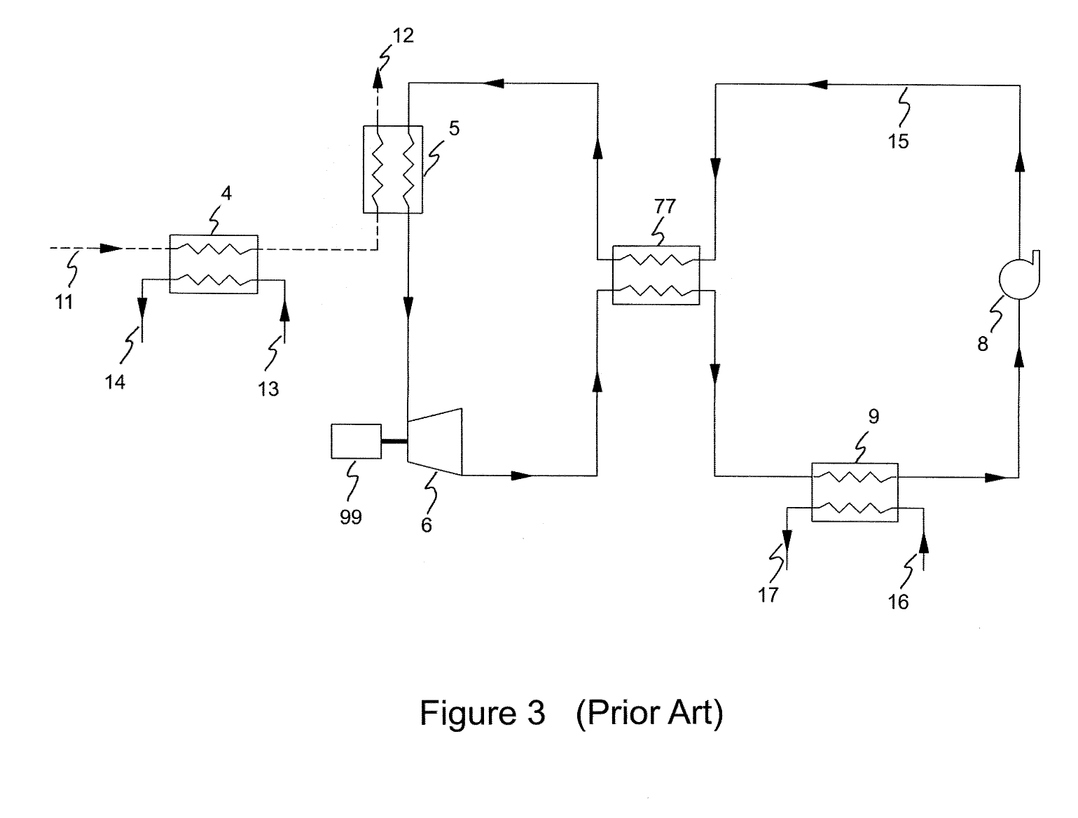

FIG. 3 is a schematic of a prior art organic Rankine cycle apparatus, with economizer. This apparatus is the same as that of FIG. 2 except the ORC working fluid passes through an economizer heat exchanger 77 whereby the liquid phase working fluid gains some heat from the gaseous state or mixed phase working fluid exiting ORC turbine 6. This heat exchanger heats the working fluid but normally not beyond the boiling point of the working fluid. The economizer thus increases the efficiency of the basic organic Rankine cycle.

### Present Disclosure

FIG. 4 is a schematic of a Rankine cycle apparatus powered by the exhaust stream of a gas turbine engine, for pre-heating fuel in a first position. FIG. 4 is the same as FIG. 3 except that a fuel heat exchanger 9 has been added after exhaust stream heat exchanger 5 but before ORC turbine 6.

In FIG. 4, the exhaust that has passed through the hot side of recuperator 4 now passes through the hot side of exhaust stream heat exchanger 5 before being released to the atmosphere via path 12. The fluid, in liquid form, of a closed-loop Rankine cycle passes through the cold side of heat exchanger 5 where it picks up heat energy from the gas turbine engine exhaust. The fluid passing through the cold side of exhaust stream heat exchanger 5 enters in the liquid state and exits in a gaseous state or mixed phase state and so increases in pressure and volume. The now-gaseous or mixed phase, pressurized working fluid then passes through a fuel heat exchanger 9 where it provides heat energy to incoming fuel stream 18. This position for fuel heat exchanger 9 would be appropriate for room temperature fuels such as diesel, gasoline or kerosene for example and would give a maximum temperature differential across heat exchanger 9. This position for fuel heat exchanger 9 would also be appropriate for cryogenic fuels such as LNG. In either case, this position would also be appropriate when the amount of energy extracted for heating fuel is a small fraction (about 0.5% to about 10%) of the heat energy available in the organic Rankine cycle working fluid.

In the engine and ORC cycle described in FIG. 2, the exhaust stream heat exchanger transfers about 240,000 Rs (240 kW) to the ORC working fluid and about 40,300 Rs (40.3 kW) is extracted by the ORC turbine.

Assume that it is required to heat diesel fuel to an elevated temperature below its boiling point. For the 377 kW gas turbine engine, full power is achieved with a diesel fuel flow of about 0.0198 kg/s. To heat the diesel from about 298 K to about 320 K (a typical temperature of the ORC fluid emerging from the exhaust stream heat exchanger), it would require about 1,020 J/s (1.0 kW). This would be extracted from the ORC flow prior to entering the ORC turbine, reducing the working fluid flow power from 240 kW to about 239 kW. Thus, pre-heating the gas turbine engine diesel fuel would not significantly reduce the power that can be extracted by the OCR turbine. It would require about 1 kW of the ORC flow power to heat other fuels, such as methane, kerosene for example, from room temperature to about 320 K.

Assume that the fuel is LNG and it is required to heat and vaporize the LNG from 110 K to about 320 K. For the 377 kW gas turbine engine, full power is achieved with a methane fuel flow of about 0.017 kg/s. To heat and vaporize the LNG would require about 7,140 J/s (7.14 kW). This would be extracted from the ORC flow prior to entering the ORC turbine, reducing the flow power from 240 kW to about 232 kW. Thus, pre-heating the gas turbine engine LNG fuel would not substantially reduce the power that can be extracted by the OCR turbine.

Fuel, to be used in the gas turbine engine, is shown entering the cold side of heat exchanger 9 via path 18 and exiting the cold side of heat exchanger 9 via path 19. The fuel stream (dot-dashed line) is heated as it passes through the cold side of fuel heat exchanger 9. After exiting fuel heat exchanger 9, the fuel may require further heating before being directed to the combustion chamber or a reheater (if used) of the gas turbine engine if it does not interfere with the fuel injection system. The fuel stream may be passed through a further, optional pre-heating apparatus 10 before being directed to the combustion chamber or reheater of the gas turbine engine.

After passing through the hot side of fuel heat exchanger 9, the gaseous or mixed phase, pressurized organic working fluid working then powers a turbine 6 which extracts the major portion of available energy from the closed cycle working fluid. Turbine 6 is shown driving an electrical generator 99. The gaseous or mixed phase working fluid then goes through the hot side of an economizer heat exchanger 77 whereby the liquid phase working fluid gains some heat from the gaseous state or mixed phase fluid exiting the ORC turbine 6. The gaseous or mixed phase working fluid then goes through the hot side of a condensing heat exchanger 7 where additional energy is extracted and rejected, causing the working fluid to condense into a liquid. Ambient air is shown entering the cold side of heat exchanger 7 via path 16 and exiting the cold side of heat exchanger 7 via path 17. As noted previously, the ambient air used in the cold side of condensing heat exchanger 7 can be replaced by ambient water in certain applications such as marine or some power generation applications for example. The now-liquid working fluid is then pumped back around the closed Rankine cycle loop by pump 8, through economizer heat exchanger 77 and then to exhaust stream heat exchanger 5.

If the fuel stream is passed through a further pre-heating apparatus 10 before being directed to the combustion chamber or reheater of the gas turbine engine, pre-heating apparatus 10 may be provide additional heat energy to the fuel stream from any number of available energy sources. For example, an energy source for pre-heating apparatus 10 may be a battery or a thermal energy storage element which obtains energy from regenerative braking. An example of this type of energy source is described in U.S. patent application Ser. No. 12/777,916 filed May 11, 2010 entitled “Gas Turbine Energy Storage and Conversion System”, which is incorporated herein by reference. Apparatus 10 may provide energy by utilizing the heat energy obtained from the hot casing of the compressors, combustors and other hot components of the gas turbine engine. For example, apparatus 10 could be a coil surrounding a hot component, or in the panel for ducting hot gases, or heat shield enclosing the engine compartment.

Pre-heating of fuel by the fuel heat exchanger 9 reduces the energy required to bring the fuel up to temperature and pressure before being combusted. Since this pre-heat energy originates in the exhaust stream of the gas turbine engine, this pre-heat process will result in a small increase in overall fuel efficiency of the gas turbine engine.

As described in U.S. patent application Ser. No. 13/090,104 filed Apr. 19, 2011, entitled “Multi-Fuel Vehicle Strategy” which was cited previously, a gas turbine engine may burn any of several fuels either separately or in combination or by switching fuels on the fly. Therefore, the present disclosure envisions that any of these fuels can be pre-heated by the apparatuses described in FIG. 4.

For example, diesel fuel or other liquid hydrocarbon fuels can be pre-heated in fuel heat exchanger 9 and then further heated by heating apparatus 10 to a temperature just below their boiling point or to a higher temperature if the fuel injection system permits. Compressed natural gas fuel (“CNG”) can be pre-heated in heat exchanger 9 causing its pressure to increase and then further heated by heating apparatus 10 until its pressure reaches the pressure required for injection into the combustion chamber or reheater of the gas turbine engine. Liquid natural gas fuel (“LNG”) can be pre-heated in heat exchanger 9 causing it to change phase into gaseous form which will result in a pressure increase. The fuel can then further heated by heating apparatus 10 until its pressure reaches the pressure required for injection into the combustion chamber or reheater of the gas turbine engine.

As can be appreciated, heat exchanger 9 may be sufficient to pre-heat the fuel. If so, then heating apparatus 10 may be omitted, de-activated or bypassed (by-pass circuit and valves not shown).

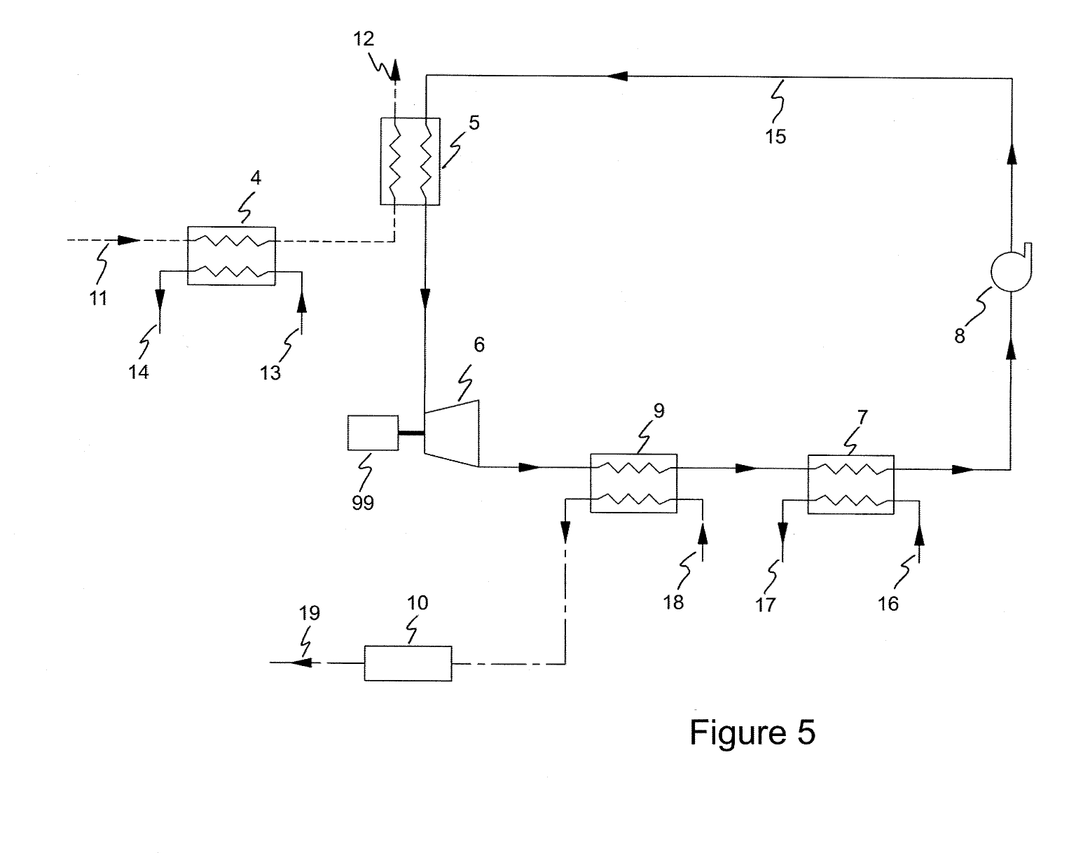

FIG. 5 is a schematic of a Rankine cycle apparatus powered by the exhaust stream of a gas turbine engine, for pre-heating fuel in a second position. This configuration is the same as that of FIG. 4 except that the fuel heat exchanger 9 has been moved from just upstream of ORC turbine 6 to just downstream of ORC turbine 6. The economizer heat exchanger is not shown in FIG. 5 although it may be added on either side of fuel heat exchanger 9. When fuel heat exchanger 9 is in this position, maximum energy is extracted by ORC turbine 6. While the temperature of the working fluid exiting ORC turbine 6 is now lower than upstream of turbine 6, the temperature difference across fuel heat exchanger 9 may be sufficient for efficient heat transfer when the fuel is LNG or expanded and cooled CNG or other cooled gaseous fuel. The amount of energy extracted for pre-heating fuel is typically not sufficient to fully condense the organic working fluid in the ORC, thus a condensing heat exchanger 7 is still required.

In the engine and ORC cycle described in FIG. 2, the exhaust stream heat exchanger transfers about 240,000 J/s (240 kW) to the ORC working fluid and about 40,300 J/s (40.3 kW) is extracted by the ORC turbine so that about 200,000 J/s is available from the OCR working fluid emerging from the OCR turbine . Assuming that the fuel is LNG and it is required to heat and vaporize the LNG from about 110 K to about 219 K (a typical temperature of the ORC fluid emerging from the OCR turbine in this example). For the 377 kW gas turbine engine, full power is achieved with a methane fuel flow of about 0.017 kg/s. To heat and vaporize the LNG would require about 3,700 J/s (3.7 kW). This would be extracted from the ORC flow prior to entering condensing heat exchanger 7, reducing the working fluid flow power from about 200 kW to about 196 kW. Thus pre-heating the gas turbine engine LNG fuel would not significantly reduce the energy required to condense working fluid in the condensing heat exchanger and the system would still require a suitably sized condensing heat exchanger.

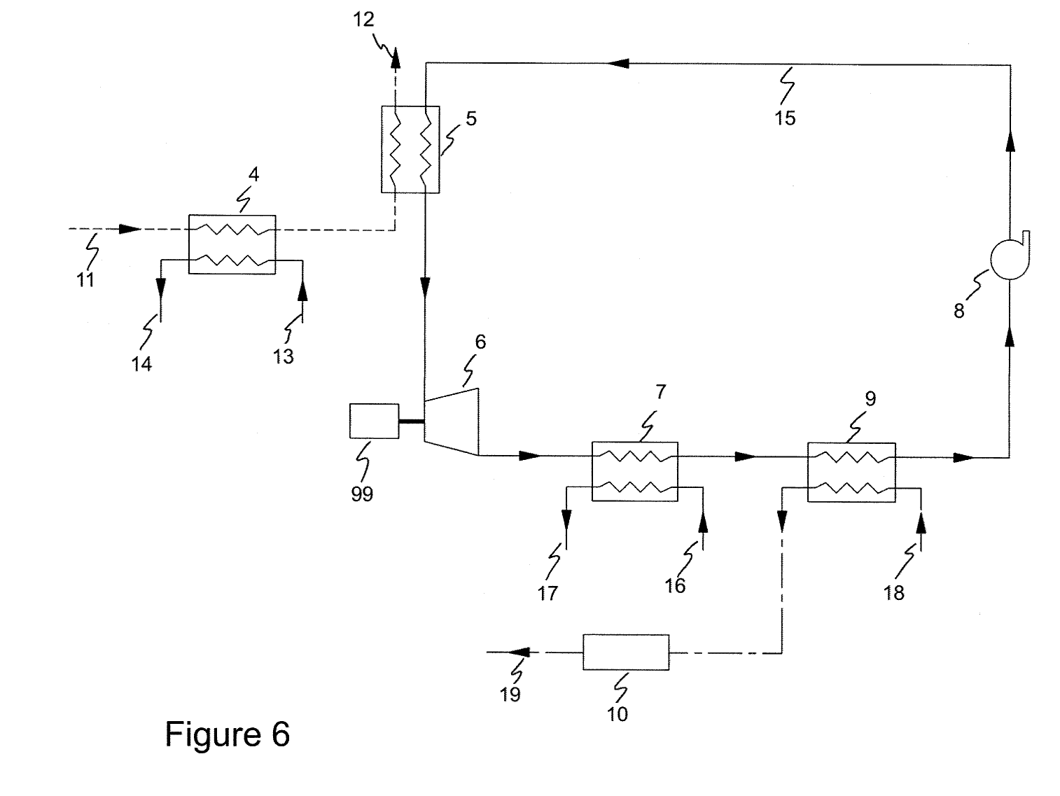

FIG. 6 is a schematic of a Rankine cycle apparatus powered by the exhaust stream of a gas turbine engine, for pre-heating fuel in a third position. This configuration is the same as that of FIG. 4 except that the fuel heat exchanger 9 has been moved from just upstream of ORC turbine 6 to just downstream of condensing heat exchanger 7. The economizer heat exchanger is not shown in FIG. 6 although it may be added between ORC turbine 6 and condensing heat exchanger 7. When fuel heat exchanger 9 is in this position, maximum energy is extracted by ORC turbine 6. While the temperature of the working fluid is now lower than upstream of condensing heat exchanger 7 and the working fluid is now a liquid, the temperature difference across fuel heat exchanger 9 may be sufficient for efficient heat transfer when the fuel is LNG or expanded and cooled CNG or other cooled gaseous fuel. The amount of energy extracted for pre-heating fuel for very cold fuels such as LNG is typically not large enough to significantly reduce the temperature of the condensed ORC working fluid.

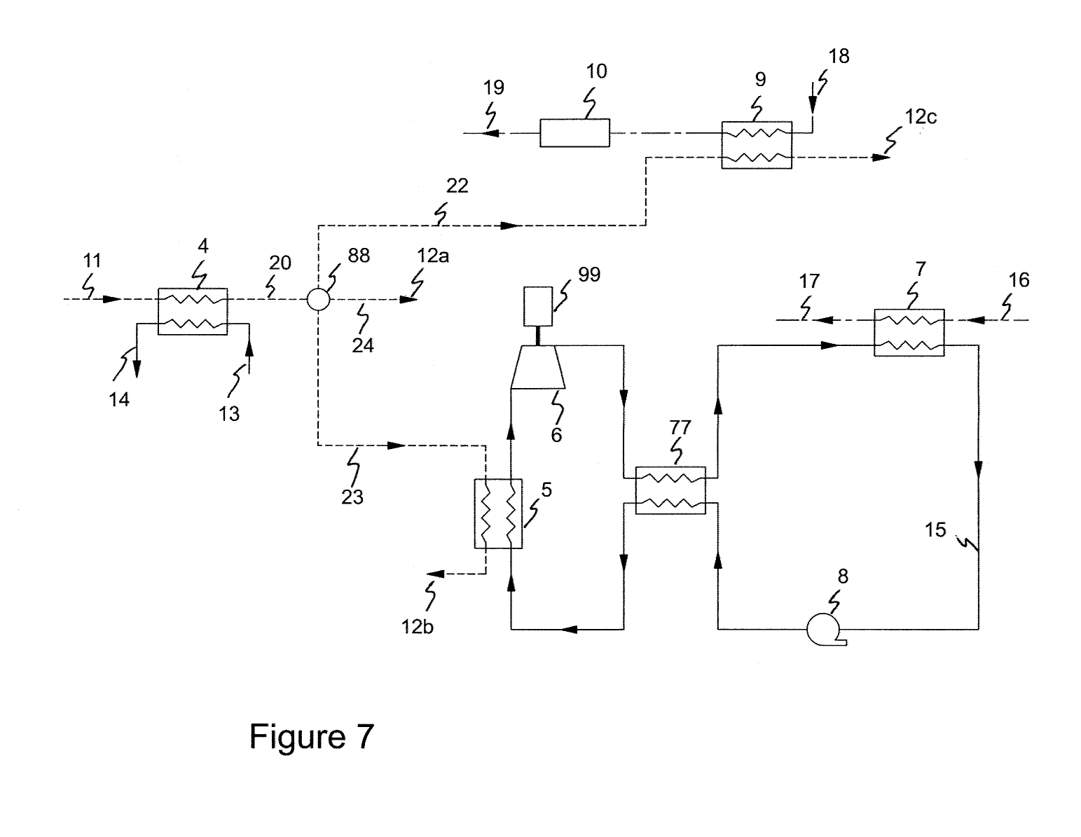

FIG. 7 is a schematic of a Rankine cycle apparatus powered by the exhaust stream of a gas turbine engine, for pre-heating fuel. This figure shows a recuperator 4 which can be, for example, the recuperator on a gas turbine engines such as shown in FIG. 1. The exhaust stream (dashed line) from the gas turbine enters recuperator 4 via path 11 which is the hot side of recuperator 4 and exits via path 20. After passing through recuperator 4, the engine exhaust that has passed through the hot side is usually released to the atmosphere. However, in this configuration, the engine exhaust may be directed to one of a heat exchanger 9 for pre heating fuel via path 22; via path 23 to a heat exchanger 5 which is part of a closed organic Rankine cycle; via path 24 to an exhaust stack directly to the atmosphere 12a; or by a combination of these three paths. The selection of exhaust path is made either manually or by an algorithm that automatically selects the most efficient path. Once a selection is made, three way valve 88 directs the exhaust stream to the selected path. As can be appreciated, valve 88 can be a proportional valve that can direct a selected percentage of the incoming exhaust stream to one, two or all three paths.

As before, air or an air-fuel mixture that flows through the gas turbine engine is shown entering the cold side of recuperator 4 via path 13 and exiting the cold side of recuperator 4 via path 14.

In FIG. 7, when all or a portion of the exhaust stream that has passed through the hot side of recuperator 4 and is directed to the closed Rankine cycle via path 23, it then passes through the hot side of a first heat exchanger 5 before being released to the atmosphere via path 12b. The fluid, in liquid form, of a closed-loop Rankine cycle passes through the cold side of a heat exchanger 5 where it picks up heat energy from the gas turbine engine exhaust. The fluid passing through the cold side of a heat exchanger 5 enters in the liquid state and exits in a gaseous state or mixed phase state and so increases in pressure and volume. The now-gaseous or mixed phase, pressurized working fluid then powers a turbine 6 which extracts energy from the closed cycle working fluid. Turbine 6 is shown driving an electrical generator 99.

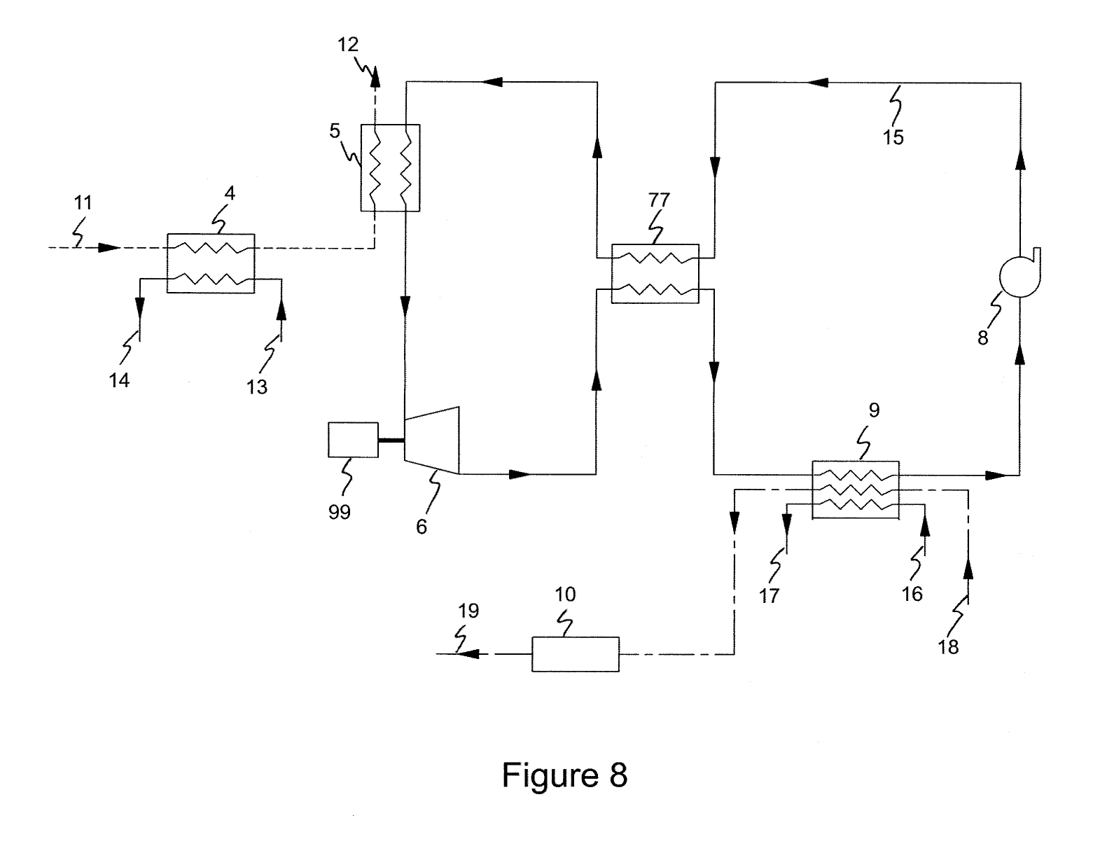

The ORC working fluid exiting ORC turbine 6 then passes through an economizer heat exchanger 77 whereby the liquid phase working fluid gains some heat from the gaseous state or mixed phase working fluid exiting ORC turbine 6. This heat exchanger heats the working fluid up to but normally not beyond the boiling point of the working fluid. The gaseous or mixed phase working fluid exiting the hot side of economizer heat exchanger 77 then flows through the hot side of a second heat exchanger 7 where additional energy is extracted causing the working fluid to condense into a liquid. Ambient air is shown entering the cold side of heat exchanger 7 via path 16 and exiting the cold side of heat exchanger 7 via path 17. Alternately, a fuel such as LNG, diesel, natural gas or the like may be one of the cooling fluid entering the cold side of heat exchanger 7 as described below in FIG. 8.

In the present disclosure, the cooled working fluid is pumped back around the closed Rankine cycle loop by pump 8 through the cold side of economizer heat exchanger 77 and then to heat exchanger 5 in a closed loop cycle around path 15.

In FIG. 7, when all or a portion of the exhaust stream that has passed through the hot side of recuperator 4 and is directed along path 22, it then passes through the hot side of a heat exchanger 9 before being released to the atmosphere via path 12c. Fuel, to be used in the gas turbine engine, is shown entering the cold side of heat exchanger 9 via path 18 and exiting the cold side of heat exchanger 9 via path 19. The fuel stream (dot-dashed line) is heated as it passes through the cold side of heat exchanger 9. After exiting heat exchanger 9, the fuel may require further heating before being directed to the combustion chamber or reheater of the gas turbine engine. The fuel stream may be passed through a further pre-heating apparatus 10 before being directed to the combustion chamber or reheater of the gas turbine engine.

Pre-heating of fuel by the third heat exchanger 9 reduces the energy required to bring the fuel up to temperature and pressure before being combusted. Since this pre-heat energy originates in the exhaust stream of the gas turbine engine, this pre-heat process will result in an increase in fuel efficiency of the gas turbine engine.

As described in U.S. patent application Ser. No. 13/090,104 filed Apr. 19, 2011, entitled “Multi-Fuel Vehicle Strategy”, which was cited previously, a gas turbine engine may burn any of several fuels either separately or in combination or by switching fuels on the fly. Therefore, the present disclosure envisions that any of these fuels can be pre-heated by the apparatuses described in FIG. 3.

Diesel fuel (or other liquid fuels such as kerosene, n-octane and the like) can be pre-heated in heat exchanger 9 and then further heated by heating apparatus 10. Compressed natural gas fuel (“CNG”) can be pre-heated in heat exchanger 9 causing its pressure to increase and then further heated by heating apparatus 10 until its pressure reaches the pressure required for injection into the combustion chamber or reheater of the gas turbine engine. Liquid natural gas fuel (“LNG”) can be pre-heated in heat exchanger 9 causing it to change phase into gaseous form which will result in a pressure increase. The fuel can then further heated by heating apparatus 10 until its pressure reaches the pressure required for injection into the combustion chamber or reheater of the gas turbine engine.

As can be appreciated, heat exchanger 9 may be sufficient to pre-heat the fuel. If so, then heating apparatus 10 may be omitted, de-activated or bypassed (by-pass circuit and valves not shown).

FIG. 8 is a schematic of an organic Rankine cycle apparatus with economizer and combined fuel heat and condensing heat exchanger. This apparatus is the same as that of FIG. 2 except that the condensing heat exchanger 9 now includes a fuel heating path in parallel with the main condenser cooling fluid. The gaseous or mixed phase working fluid from ORC turbine 6 passes through the hot side of condensing heat exchanger 9 where energy is extracted, causing the working fluid to condense into a liquid. Ambient air or water is shown entering the cold side of heat exchanger 7 via path 16 and exiting the cold side of heat exchanger 7 via path 17. Fuel, to be used in the gas turbine engine, is shown entering the cold side of heat exchanger 9 via path 18 and exiting the cold side of heat exchanger 9 via path 19. The fuel stream (dot-dashed line) is heated as it passes through the cold side of heat exchanger 9. The amount of heat removed by the fuel is typically small compared to the amount of heat removed by the ambient air or water flow. After exiting heat exchanger 9, the fuel may require further heating before being directed to the combustion chamber or reheater of the gas turbine engine. The fuel stream may be passed through a further pre-heating apparatus 10 before being directed to the combustion chamber or reheater of the gas turbine engine. The now-liquid ORC working fluid is then pumped back around the closed Rankine cycle loop by pump 8 through the cold side of economizer heat exchanger 77 and then to exhaust stream heat exchanger 5.

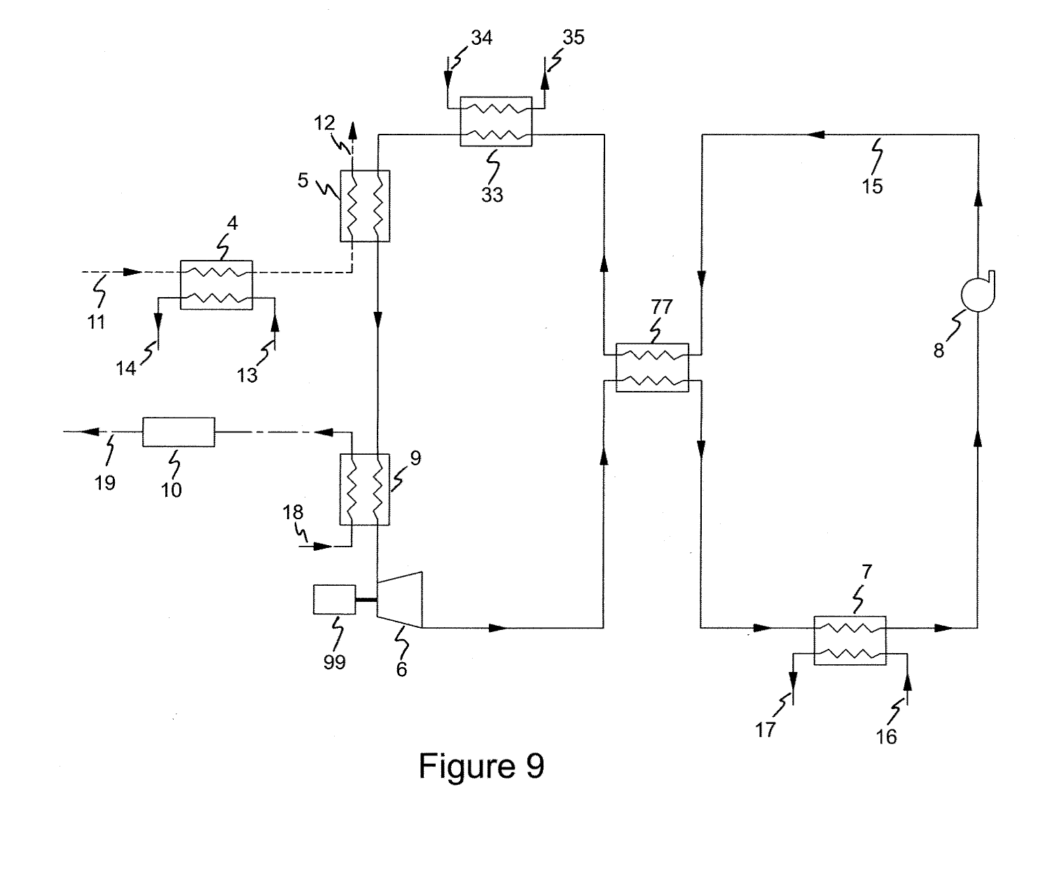

FIG. 9 is a schematic of a Rankine cycle apparatus powered by a portion of the heat that is to be rejected by an intercooler and the exhaust stream of a gas turbine engine, for pre-heating fuel in a first position. In a gas turbine engine such as described in FIG. 1, an intercooler is utilized to shed heat, at approximately constant pressure, from the output gas from the low pressure compressor and this heat is commonly rejected into the atmosphere and its energy is lost. Typically, ambient air is used in an intercooler to cool the output gas from the low pressure compressor (an intercooler is a heat exchanger). It therefore is possible to place an additional heat exchanger (referred herein as the intercooler heat exchanger) between the output of a compressor and the input of an intercooler. Referring to FIG. 1 for example, it is possible to use the heat from the output gas from the low pressure compressor to first add energy and increase the temperature of the liquid state working fluid in an organic Rankine cycle before ORC the liquid state working fluid passes through the exhaust stream heat exchanger 5.

FIG. 9 is the same as FIG. 4 except that the liquid state organic working fluid is heated first by intercooler heat exchanger 33 and then by exhaust stream heat exchanger 5. The organic working fluid exiting the cold side of intercooler heat exchanger 33 may be in a liquid, gaseous state or mixed phase state. The organic working fluid exiting the cold side of exhaust stream heat exchanger 5 is in a gaseous state or mixed phase state.

In the engine and ORC cycle described in FIG. 2, the exhaust stream heat exchanger transfers about 240,000 J/s (240 kW) to the ORC working fluid at full engine power and about 40,300 J/s (40.3 kW) is extracted by the ORC turbine.

At full engine power, it is possible to transfer about 140,000 J/s to the ORC fluid through the intercooler heat exchanger and this would increase the temperature of the ORC fluid and therefore tend to reduce the heat transferred from the exhaust stream heat exchanger. However, the net heat added to the ORC fluid by both intercooler and exhaust stream heat exchangers would be higher than the heat transfer form the exhaust stream heat exchanger alone.

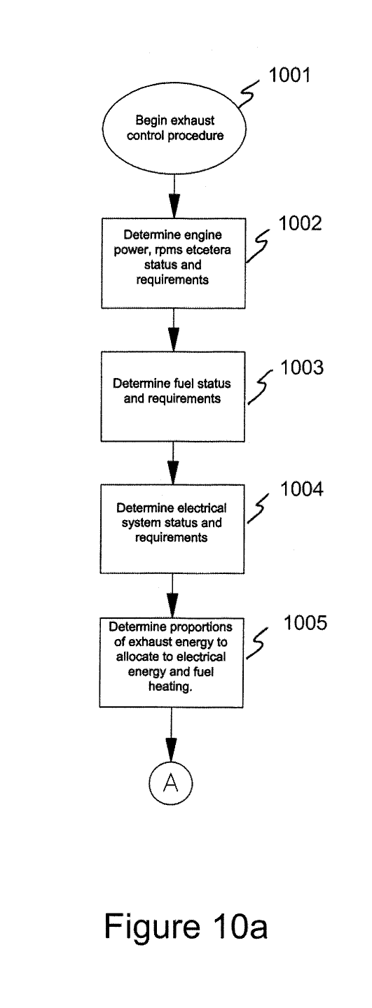

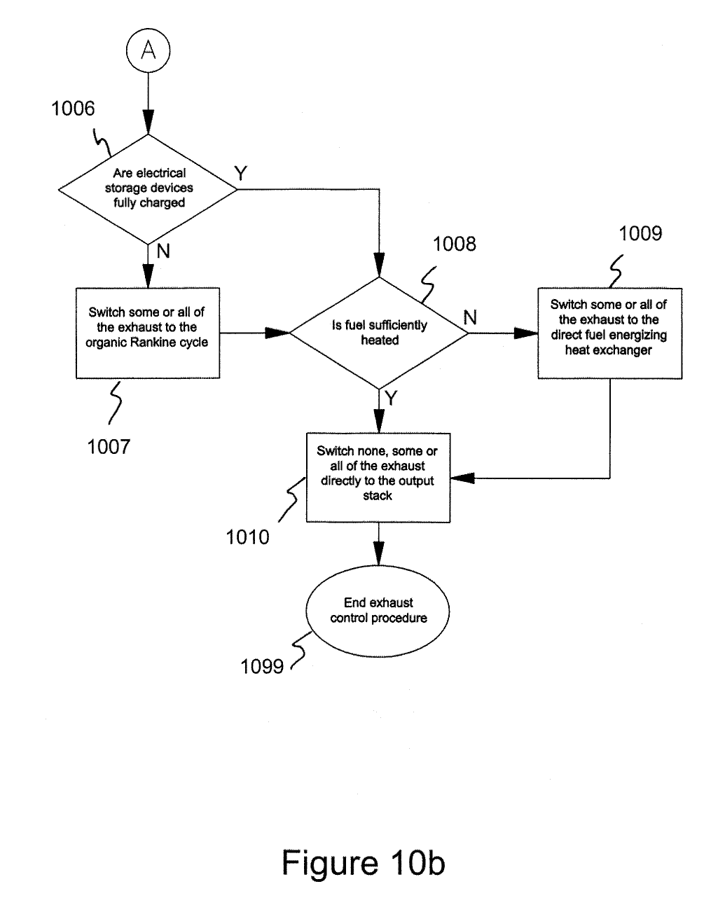

FIGS. 10a and 10b is a flow chart for switchable exhaust control. Exhaust control can be implemented by an on-board computer that automatically interrogates the appropriate sensors, such as for example, state-of-charge of an energy storage battery, temperature of a fuel supply, power level of the engine and the like. In step 1001, the exhaust control routine is initiated. In step 1002, the status of the engine is determined by sensing engine power, rpms of the turbines and the like and future engine requirements are estimated. In step 1003, the status of the fuel system is determined by sensing fuel consumption rate, fuel temperature, combustor temperature and the like and future fuel requirements are estimated. In step 1004, the status of the electrical system is determined by sensing energy storage state-of-charge, auxiliary power consumption, engine power and the like and future electrical requirements, such as auxiliary power, engine speed and the like are estimated (engine speed may be used in determining if a power boost is needed or if a hybrid transmission will be operated in all or partial electrical mode). This sensed data and estimated requirements are used in step 1005 to determine the setting of a proportional or other type of valve that determines where the engine exhaust stream is directed (fuel heat exchanger for pre heating fuel; an exhaust stream heat exchanger which is part of a closed organic Rankine cycle; directly out an exhaust stack to the atmosphere; or by a combination of these three paths). The determining step 1005 can be implemented as shown in the remaining sequence of steps. In step 1006, if all electrical storage devices are charged and there is no additional requirement for auxiliary power, then the procedure goes to step 1008. In step 1008, if the fuel requires no pre-heating, then the procedure goes to step 1010 where all the exhaust may be switched directly out the exhaust stack into the atmosphere. In step 1006, if there remains a need for charging electrical storage devices or there is additional requirement for auxiliary power, then the procedure goes to step 1007 where some or all of the exhaust is directed through the exhaust stream heat exchanger to operate the ORC. Then the procedure goes to step 1008. In step 1008, if the fuel requires no pre-heating, then the procedure goes to step 1010 where none or some of the exhaust may be switched directly out the exhaust stack into the atmosphere. In step 1008, if the fuel requires pre-heating, then the procedure goes to step 1009 where some or all of the exhaust is directed through the fuel energizing heat exchanger. Then the procedure goes to step 1010 where none or some of the exhaust may be switched directly out the exhaust stack into the atmosphere. Then the exhaust control routine is terminated.

The disclosures presented herein may be used on gas turbine engines used in vehicles or in gas turbine engines used in stationary applications such as, for example, power generation and gas compression. In the former application, it is important that the condensing heat exchanger in an ORC apparatus be compact and this can be achieved in part by positioning the condensing heat exchanger on the vehicle where it can take advantage of the ram air effect at least while the vehicle is moving forward.

The exemplary systems and methods of this disclosure have been described in relation to preferred aspects, embodiments, and configurations. Modifications and alterations will occur to others upon a reading and understanding of the preceding detailed description. It is intended that the disclosure be construed as including all such modifications and alterations insofar as they come within the scope of the appended claims or the equivalents thereof. To avoid unnecessarily obscuring the present disclosure, the preceding description omits a number of known structures and devices. This omission is not to be construed as a limitation of the scopes of the claims. Specific details are set forth to provide an understanding of the present disclosure. It should however be appreciated that the present disclosure may be practiced in a variety of ways beyond the specific detail set forth herein.

Furthermore, while the exemplary aspects, embodiments, and/or configurations illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated.

Also, while the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the inventions can be used. As will be appreciated, it would be possible to provide for some features of the inventions without providing others.

The present invention, in various embodiments, includes components, methods, processes, systems and/or apparatus substantially as depicted and described herein, including various embodiments, sub-combinations, and subsets thereof Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, for example for improving performance, achieving ease and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter

What is claimed is:

1. An apparatus, comprising:
a heat exchange system operable to transfer thermal energy from an exhaust stream of a gas turbine engine to a fuel stream of a gas turbine engine to preheat and/or pressurize the fuel stream for combustion in the gas turbine engine.

2. The apparatus of claim 1, wherein the heat exchange system comprises a first heat exchanger to transfer thermal energy from the exhaust stream of a gas turbine engine to a working fluid of a closed organic Rankine cycle (“ORC”) and a second heat exchanger to transfer thermal energy from the working fluid to the fuel stream.

3. The apparatus of claim 2, wherein the second heat exchanger is positioned upstream of a closed organic Rankine cycle (“ORC”) turbine and wherein the fuel stream comprises at least one of a cryogenic fuel, a below ambient temperature gaseous fuel, an ambient temperature gaseous fuel and an ambient temperature liquid fuel.

4. The apparatus of claim 2, wherein the second heat exchanger is positioned downstream of an organic Rankine cycle (“ORC”) turbine and upstream of a condensing heat exchanger and wherein the fuel stream comprises at least one of a cryogenic fuel, a below ambient temperature gaseous fuel and a below ambient temperature liquid fuel.

5. The apparatus of claim 2, wherein the second heat exchanger is positioned downstream of an organic Rankine cycle (“ORC”) turbine and a condensing heat exchanger of a closed organic Rankine cycle (“ORC”) and wherein the fuel stream comprises at least one of a cryogenic fuel, a below ambient temperature gaseous fuel and a below ambient temperature liquid fuel.

6. The apparatus of claim 2, wherein the heat exchange system comprises an intercooler heat exchanger to transfer thermal energy from an outlet gas of a compressor to the working fluid upstream of the first heat exchanger.

7. The apparatus of claim 2, further comprising an economizer heat exchanger positioned downstream of an organic Rankine cycle (“ORC”) turbine and upstream of a condensing heat exchanger.

8. The apparatus of claim 2, wherein the heat exchange system comprises a condensing heat exchanger positioned downstream of an organic Rankine cycle (“ORC”) turbine and an economizer heat exchanger and wherein the condensing heat exchanger transfers thermal energy to at least two of the fuel stream, air and water.

9. A method, comprising:
transferring, by a heat exchange system, thermal energy from an exhaust stream of a gas turbine engine to a fuel stream of a gas turbine engine to preheat and/or pressurize the fuel stream for combustion in the gas turbine engine.

10. The method of claim 9, wherein the heat exchange system comprises a first heat exchanger to transfer thermal energy from the exhaust stream to a working fluid of a closed organic Rankine cycle (“ORC”) and a second heat exchanger to transfer thermal energy from the working fluid to the fuel stream.

11. The method of claim 10, wherein the second heat exchanger is positioned upstream of an organic Rankine cycle (“ORC”) turbine and wherein the fuel stream comprises at least one of a cryogenic fuel, a below ambient temperature gaseous fuel, an ambient temperature gaseous fuel and an ambient temperature liquid fuel.

12. The method of claim 10, wherein the second heat exchanger is positioned downstream of an organic Rankine cycle (“ORC”) turbine and upstream of a condensing heat exchanger and wherein the fuel stream comprises at least one of a cryogenic fuel, a below ambient temperature gaseous fuel and a below ambient temperature liquid fuel.

13. The method of claim 10, wherein the second heat exchanger is positioned downstream of an organic Rankine cycle (“ORC”) turbine and a condensing heat exchanger and wherein the fuel stream comprises at least one of a cryogenic fuel, a below ambient temperature gaseous fuel and a below ambient temperature liquid fuel.

14. The method of claim 10, wherein the heat exchange system comprises an intercooler heat exchanger to transfer thermal energy from an outlet gas of a low pressure compressor to the working fluid upstream of the first heat exchanger.

15. The method of claim 10, further comprising an economizer heat exchanger positioned downstream of an organic Rankine cycle (“ORC”) turbine and upstream of a condensing heat exchanger.

16. The method of claim 10, wherein the heat exchange system comprises a condensing heat exchanger positioned downstream of an organic Rankine cycle (“ORC”) turbine and an economizer heat exchanger and wherein the condensing heat exchanger transfers thermal energy to at least two of the fuel stream, air and water.

17. A system, comprising:
an exhaust path selector, the exhaust path selector being operable to select a path for a gas turbine engine exhaust gas, wherein a first path comprises a heat exchanger to transfer thermal energy from the exhaust gas to a fuel stream for the gas turbine engine, a second path comprises an exhaust to the environment, and a third path comprises a closed organic Rankine cycle apparatus.

18. The system of claim 17, wherein the exhaust path selector comprises a computational module operable to determine a state of the gas turbine engine and select among the first, second, and third paths based on the determined input.

19. The system of claim 17, wherein the input determination comprises a plurality of the following: a gas turbine engine power, a free power turbine revolutions-per-minute, a fuel status, a system status, an engine requirement, a system requirement, a proportion of exhaust gas energy to allocate tone or more of electrical energy generation and fuel heating, a state of charge of an electrical energy storage device, and an gas turbine engine input temperature of the fuel stream.

20. The system of claim 19, wherein the computational module applies the following rules:
(A) when a charge of the electrical energy storage device is less than a selected charge threshold, directing at least a portion of the exhaust gas along the third path to an electrical generator in electrical communication with the electrical energy storage device;
(B) when the input temperature of the fuel stream is less than a selected temperature threshold, directing at least a portion of the exhaust gas along the first path to the heat exchanger; and
(C) when neither rule (A) nor (B) applies, directing at least a portion of the exhaust gas along the second path to the exhaust.

21. A method, comprising:
a) sensing at least one of a state-of-charge of an energy storage battery, rate of consumption of auxiliary power, temperature of a fuel supply, rate of consumption of a fuel supply, and power level of an engine;
b) based on the sensed at least one of a state-of-charge of an energy storage battery, rate of consumption of auxiliary power, temperature of a fuel supply, rate of consumption of a fuel supply, and power level of an engine, determining a proportion of an exhaust stream directed at least one of a fuel heat exchanger for pre heating fuel, an exhaust stream heat exchanger which is part of a closed organic Rankine cycle and an exhaust stack fluidly connected to the atmosphere; and
c) in response to step (b), setting a control valve to direct the exhaust stream to the at least one of a fuel heat exchanger for pre heating fuel, an exhaust stream heat exchanger which is part of a closed organic Rankine cycle and an exhaust stack fluidly connected to the atmosphere.

22. A tangible or non-transient computer readable medium comprising microprocessor-executable instructions operable to perform the steps of claim 21.

23. A method, comprising:
a) estimating the time of at least one of a projected requirement for a state-of-charge of an energy storage battery, rate of consumption of auxiliary power, temperature of a fuel supply, rate of consumption of a fuel supply and power level of an engine;
b) based on the at least one of a of a projected requirement for a state-of-charge of an energy storage battery, rate of consumption of auxiliary power, temperature of a fuel supply, rate of consumption of a fuel supply and power level of an engine, estimating the proportions of an exhaust stream to be directed at least one of a fuel heat exchanger for pre heating fuel, an exhaust stream heat exchanger which is part of a closed organic Rankine cycle and an exhaust stack fluidly connected to the atmosphere; and
c) in response to step (b), at the estimated time, setting a control valve to direct the exhaust stream to at least one of a fuel heat exchanger for pre heating fuel, an exhaust stream heat exchanger which is part of a closed organic Rankine cycle and an exhaust stack fluidly connected to the atmosphere.

24. A tangible or non-transient computer readable medium comprising microprocessor-executable instructions operable to perform the steps of claim 23.

25. An apparatus, comprising:
an organic Rankine cycle operatively connected to a gas turbine engine;
at least one of an electrical energy generator and a second compressor powered by a turbine in the organic Rankine cycle; and
at least one intercooler heat exchanger in fluid communication with the organic Rankine cycle to transfer thermal energy from a compressed gas output of a compressor of the gas turbine engine to the working fluid.

26. The apparatus of claim 25, wherein the intercooler heat exchanger is in fluid communication with the compressor output and is positioned between the compressor and an intercooler and wherein the working fluid of the organic Rankine cycle is in a liquid phase when entering a cold side of the intercooler heat exchanger.

27. A method, comprising:
providing an organic Rankine cycle, a gas turbine engine, at least one of an electrical energy generator and a second compressor, and at least one intercooler heat exchanger;
transferring, by the intercooler heat exchanger. thermal energy from a compressed gas output of a compressor of the gas turbine engine to a working fluid of the Rankine cycle to form a heated working fluid; and
driving, by the heated working fluid, a turbine, the turbine being operatively connected to the at least one of an electrical energy generator and a second compressor.

28. The method of claim 27, further comprising:
transferring thermal energy from an exhaust gas of the gas turbine engine to the heated working fluid upstream of the turbine.
